(19) United States
(12) Patent Application Publication
(10) Pub. No.: US 2003/0148776 A1
(43) Pub. Date: Aug. 7, 2003

(54) Moslem direction indicator

(76) Inventors: Jean Ciechanowiecki, Weston, FL (US); Hossein Sazfgar, Monfronge (FR)

Correspondence Address: NIXON & VANDERHYE P.C., 8th Floor, 1100 North Glebe Road, Arlington, VA, 22201-4714, US

(21) Appl. No.: 10/060,293

(22) Filed: Feb. 1, 2002

(51) Int. Cl. H04Q 7/20

(52) U.S. Cl. 455/457; 342/357.1; 701/207

(57) ABSTRACT

This Invention relates to a method and system for the illustration of the North direction on the display means of a cellular phone. More specifically the present invention includes a method and system for using directional indicators or the cellular base station and tracking technology to communicate to a cellular phone or device the direction of North or any other direction which is implicitly arranged around North. Furthermore the present invention relates to the indication of direction for religious groups which pray in the direction of prominent places such as Mecca.

### TECHNICAL FIELD

This Invention relates to a method and system for the illustration of the direction on the display means of a cellular phone. More specifically the present invention includes a method and system for using device localization techniques or the cellular base station and tracking technology to communicate to a cellular phone or device the direction of North or any other direction which is implicitly arranged around North.

Moreover the present invention allows for the use of the invention for prayers by certain religious groups around the world and for general navigation. It is envisaged that this invention would be a valuable aid to people of the Moslem faith where they pray each day in the direction of Mecca at predefined times.

The present invention would assist cellular phone users to determine the position of North without having to purchase a compass or the like. It is envisaged that a normal or standard cellular phone could be used.

### BACKGROUND ART

Furthermore with the introduction of cellular positioning systems or tracking technologies for cellular it would be able to communicate a signal to a cellular device or phone to indicate to a user the direction of North.

The existing problem of coarse is that although GPS technology exists it is expensive and cumbersome to carry around. This invention will be a cost effective tool and give users access to direction finding and positioning.

Should there be a simplified method and system for indicating on a cellular device which direction is North it would eliminate the need for a compass or expensive GPS devices.

### OBJECTIVES OF THE INVENTION

Accordingly it is an object of the present invention to provide a method and system for the illustration of the North direction on the display means of a cellular phone and/or to show the direction of a places like Mecca, and with which the applicant believes disadvantages of known systems may at least be alleviated.

### DISCLOSURE OF INVENTION

According to the 1^{st} aspect of the invention there is included a method for displaying direction on a cellular phone, the method including the steps of:

providing display means associated with the cellular phone:

providing for a direction request to any one or more of: a service provider and a network operator:

communicating data in relation to the request to the cellular phone; and

displaying at least one direction on the display means of the cellular phone.

According to the 2^{nd} aspect of the invention the service provider or network operator may use data relating to the base station locations to communicate in relation to the request, the direction

According to the 3^{rd} aspect to the invention the cellular phone may have pictures of prominent places which is placed relative to the direction indicated

According to the 4^{th} aspect of the invention the display of direction may be degrees or parts thereof.

According to the 5^{th} aspect of the invention the pictures may include a religious place or landmark.

According to the 6^{th} aspect of the invention the religious place or landmark may be Mecca

According to the 7^{th} aspect of the invention the cellular phone may have an alarm or messaging function to indicate the start and end of a prayer session.

According to the 8^{th} aspect of the invention the cellular phone may produce a religious message or extracts of religious books or scripture which is presented on the display means.

According to the 9^{th} aspect of the invention the religious message or extracts of religious books or scripture may be stored in the memory of the phone or be sent to the user over the network

According to the 10^{th} aspect of the invention there is included a system for displaying direction on a cellular phone, the system comprising:

display means associated with the cellular phone:

means for requesting direction to any one or more of: a service provider and a network operator:

means for communicating data in relation to the request to the cellular phone: and

means for displaying at least one direction on the display means of the cellular phone

### BRIEF DESCRIPTION OF DRAWINGS

Preferred embodiments of the invention will now be described by means of non-limiting examples only, with reference to the accompanying diagrams wherein:

FIG. 1 is a cellular phone;

FIG. 2 illustrates the communication infrastructure;

FIG. 3 illustrates the process for determining North;

FIG. 4 relates to the simplified method and system for illustrating North on the display device of a cellular phone; and

FIG. 5 relates to the use of the invention to illustrate the direction of a religious place.

### BEST MODES FOR CARRYING OUT THE INVENTION

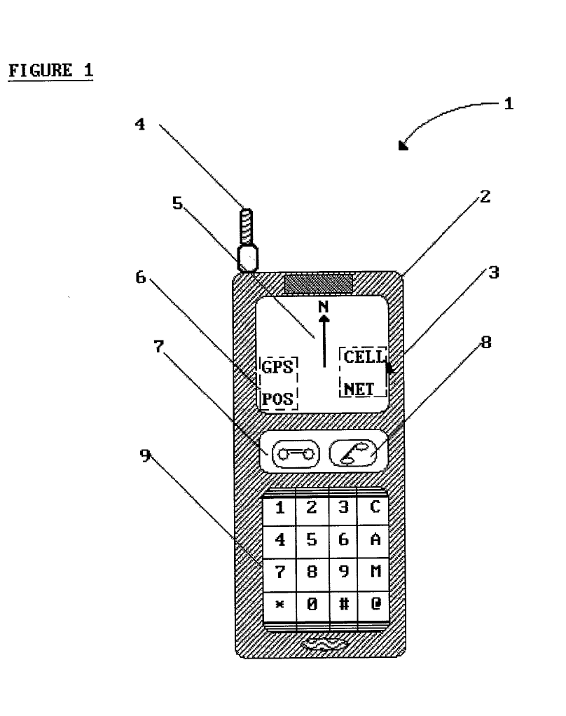

Turning to FIG. 1, there is included a cellular phone 1 comprising a casing 2 and display means 3 indicating for example the network operator as well as the mode 6 and an indication of the North direction 5. The cellular phone or device may also include a dial or pin pad 9 as well as operation buttons 7 and 8. In use the cellular base station would communicate via the aerial 4 to the device to indicate the North direction.

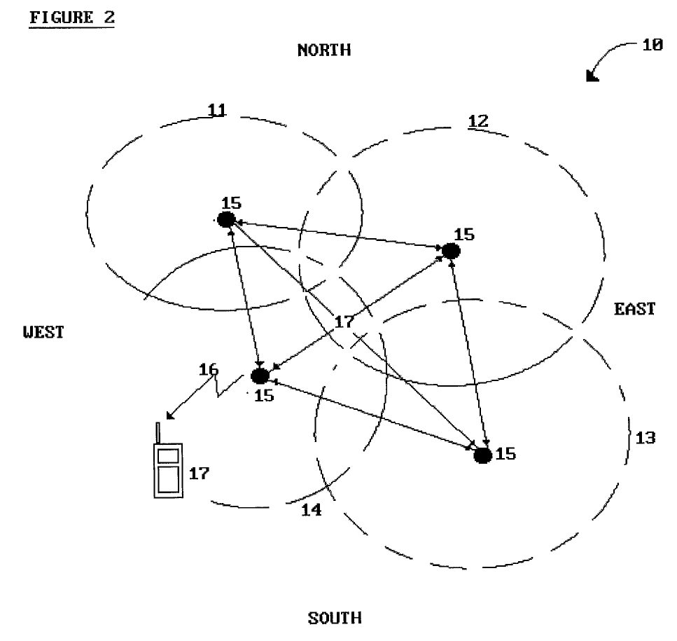

FIG. 2 more specifically illustrates the communication infrastructure 10 including a cellular network with multiple radio cells 11, 12, 13 and 14 with associated base stations 15. These base stations are in communication with each other directly and/or indirectly 17. The Cellular network would communicate 16 to the cellular phone or device 17 which direction is North and display it on the display means.

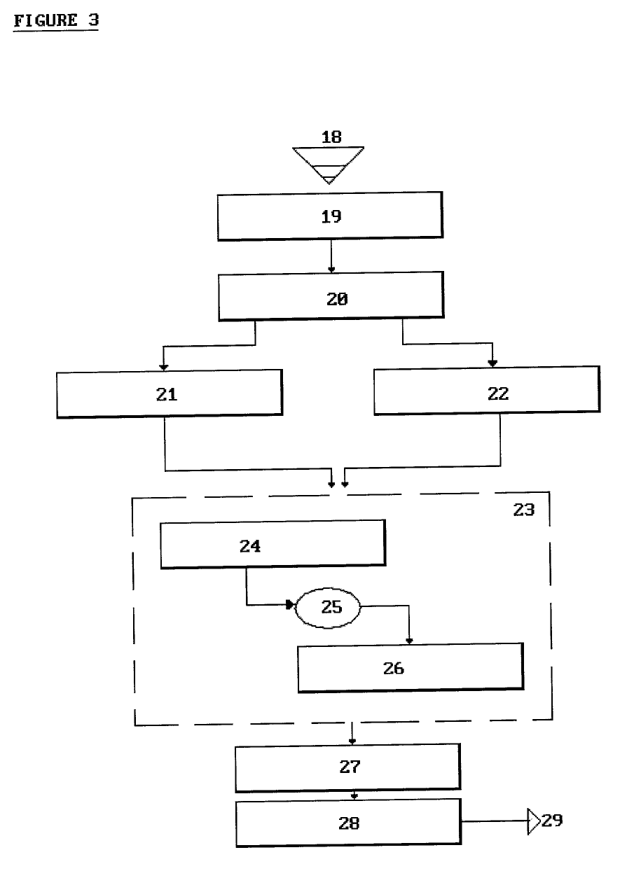

In FIG. 3 the process for determining North is illustrated 18 including a user requesting an indication of North 19 after which the phone may dail-in 21 or activate an SMS application 22. The process 23 may involve determining in which cell the user is 24 and compare 25 it with data relating to direction and/or other cells 26. A signal is then communicated 27 to the user device i.e. a cellular phone 28 and the direction of North is then displayed thereon 29.

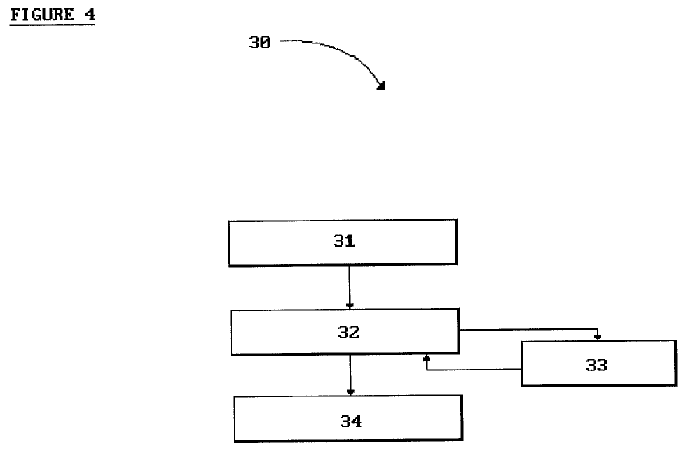

FIG. 4 relates to the simplified method and system for illustrating North on the display device of a cellular phone 30 including a user requesting 31 the illustration of the direction The device would communicate to the network 32 which would determine the direction or signal the direction 33 and communicate it back to the user 34 via the cellular device

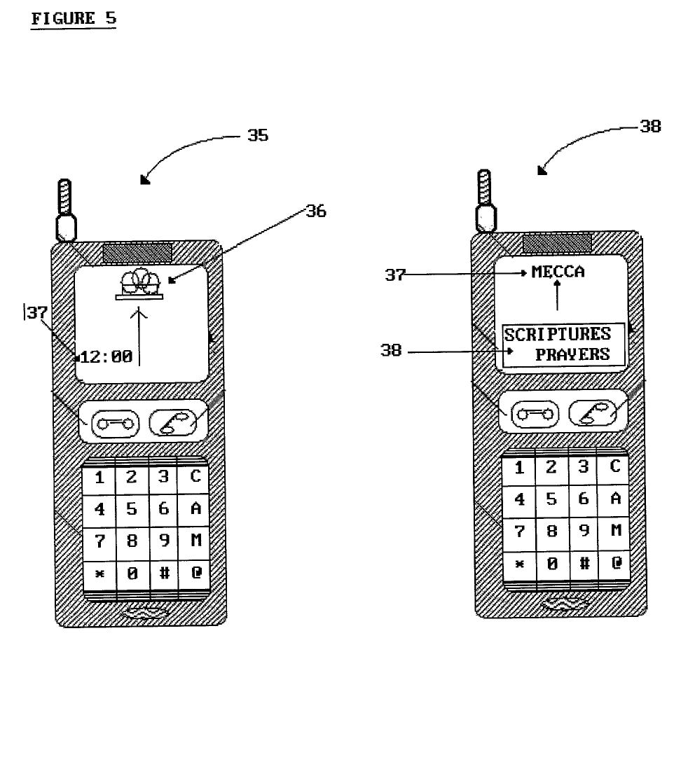

FIG. 5 relates to the use of the invention to illustrate 35 the direction of a religious place like Mecca 36 and optionally the time 37 that prayers will start and/or finish. Also included within the scope of the invention and the application the cellular phone 38 may include text to indicate the location 37and scriptures and prayers 38 may be displayed and/or messages relating to the practice of the religion. This information or date may be stored on the mammary of the phone or SIM card and/or be downloaded as an SMS or a Data Message or form part of a WAP Service. Furthermore the system and/or phone could be used to sound an alarm or send a notification when prayers is to start and/or should finish.

1. A method for displaying direction on a cellular phone, the method including the steps of:
providing display means associated with the cellular phone:
providing for a direction request to any one or more of: a service provider and a network operator:
communicating data in relation to the request to the cellular phone: and
displaying at least one direction on the display means of the cellular phone.

2. A method as claimed in claim 1 wherein the service provider or network operator uses data relating to the base station locations to communicate in relation to the request the direction.

3. A method as claimed in claim 1 wherein the cellular phone has one or more pictures of prominent places which is placed relative to the direction indicated.

4. A method as claimed in claim 1 wherein the display of direction is degrees or parts thereof.

5. A method as claimed in claim 3 wherein the pictures is taken to include a religious place or landmark.

6. A method as claimed in claim 5 wherein the religious place or landmark is Mecca.

7. A method as claimed in claim 1 wherein the cellular phone has an alarm or messaging function to indicate one or more of: the start and end of a prayer session.

8. A method as claimed in claim 1 wherein the cellular phone produces a religious message or extracts of relgios books or scripture which is presented on the display means.

9. A method as claimed in claim 8 wherein the invention the religious message or extracts of religious books or scripture is stored in the memmory of the phone or be sent to the user over the network

10. A system for displaying direction on a cellular phone, the system comprising:
display means associated with the cellular phone:
means for requesting direction to any one or more of: a service provider and a network oparator:
means for communicating data in relation to the request to the cellular phone: and
means for displaying at least one direction on the display means of the cellular phone
